(19) United States
(12) Patent Application Publication
(10) Pub. No.: US 2010/0318397 A1
(43) Pub. Date: Dec. 16, 2010

(54) SYNCHRONIZING DELEGATION MODELS BETWEEN DISPARATE SERVERS

(75) Inventors: Vishal Singh, Redmond, WA (US); Murtaza H. Hakim, Sammamish, WA (US); Hao Yan, Redmond, WA (US); Nishant P. Choudhary, Redmond, WA (US); Vijay Kishen Hampapur Parthasarathy, Sammamish, WA (US); Amit Gupta, Redmond, WA (US); Dhigha D. Sekaran, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/483,245

(22) Filed: Jun. 12, 2009

(51) Int. Cl. G06Q 10/00; H04L 29/06; G06F 15/16; G06Q 50/00

(52) U.S. Cl. 705/9; 726/4; 709/206; 709/203; 726/1

(57) ABSTRACT

Architecture that provides synchronization of delegation permissions between discrete delegation models. For example, the synchronization of the delegation permissions (of a delegator and delegatee) can be performed between a delegation component of a scheduling system and a delegation component of a conferencing system such that the delegatee not only accesses the scheduling system on behalf of the delegator but also the conferencing system on behalf of the delegator. A synchronization component synchronizes the delegation permissions between the server systems (delegation components). Once synchronized, the delegatee administers the communications session, based on on-behalf-of information is validated, the delegatee can then establish the communications session.

### BACKGROUND

As employees become busier, the ability to delegate tasks finds particular importance in meeting and accomplishing goals. For example, busy executives can delegate communication tasks to assistants who take care of answering and filtering calls based on priority and relevance. The assistant can also make calls and participate in conferences on behalf of the executive, thus saving the executive time. In such cases the assistant is acting as a representative of the executive.

However, services do not provide a widespread delegation model that allows delegation across disparate services. For example, typical calendaring and conferencing systems are not synchronized such that if the executive assigns delegation permissions using one calendaring system, the same relationship will be honored by the conferencing system so that the assistant can perform the conferencing on behalf of the boss.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

A delegation synchronization architecture is disclosed that synchronizes the delegation permissions of a delegator to a delegatee between at least two discrete delegation systems (or models), such as for messaging servers and conferencing servers. For example, the synchronization of delegation permissions can be performed between a delegation component of a scheduling system and a delegation component of a conferencing system such that the delegatee can not only access the scheduling system on behalf of the delegator but also the conferencing system on behalf of the delegator.

A synchronization component interfaces directly or indirectly to the delegation components of the disparate systems, reads the delegation permissions stored on one system, determines if the delegation permissions are defined (established) in the delegation components of the other systems, and if not, facilitates the establishment of the permissions on the other systems. Once the delegation permissions are synchronized between the delegation components, the delegatee can schedule, edit, or delete an online meeting and/or conference call for the delegator on all of the synchronized systems.

In one example, the delegatee schedules the communications session, and in response the synchronization component transmits on-behalf-of information to a conferencing server. This on-behalf-of information is sent to the conferencing server in a protocol (e.g., IP-based) to provide permissions on the communications session. Once the on-behalf-of information is validated, the delegatee can then establish the communications session. A delegation header can be utilized to transmit the on-behalf-of information to the conferencing server. Specifically, the delegation header communicates the delegation action of the delegatee via session initiation Protocol (SIP), for example, and the delegation header facilitates validation of the delegatee according to the synchronized delegation permissions. If the delegation permissions match the delegation settings in the conferencing server, the conferencing server will create the communications session utilizing the on-behalf-of information from the header.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented delegation system in accordance with the disclosed architecture.

FIG. 2 illustrates an embodiment of a delegation system for synchronizing delegation permissions between messaging and conferencing servers.

FIG. 3 illustrates an alternative embodiment of a delegation system where synchronization is provided directly between servers.

FIG. 4 illustrates a computer-implemented delegation method.

FIG. 5 illustrates further aspects in the delegation method of FIG. 4.

FIG. 6 illustrates still further aspects in the delegation method of FIG. 4.

FIG. 7 illustrates a more specific method of synchronizing delegation permissions between a messaging server and a conferencing server.

FIG. 8 illustrates a method of sending on-behalf-of information to a conferencing server.

FIG. 9 illustrates a block diagram of a computing system operable to execute the delegation synchronization in accordance with the disclosed architecture.

FIG. 10 illustrates an exemplary computing environment operable to provide delegation synchronization.

### DETAILED DESCRIPTION

The disclosed architecture provides the synchronization delegation permission models of at least two discrete delegation systems (e.g., messaging server and conferencing server). For example, a delegatee can function on behalf of a delegator based on delegation permissions such as to schedule conference calls or on-line meetings, for example. The delegator assigns delegation to the delegatee in one server (e.g., a messaging), and ensures that the same delegation permissions exist in another server (e.g., conferencing). The appropriate information is sent in a protocol header that allows the delegatee to setup conference calls or on-line meetings on behalf of the delegator.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

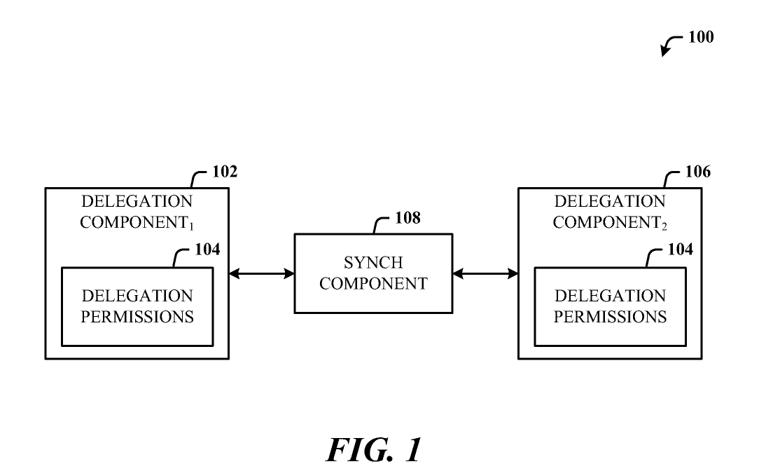

FIG. 1 illustrates a computer-implemented delegation system 100 in accordance with the disclosed architecture. The delegation system 100 includes discrete delegation components for processing delegation permissions. For example, a first delegation component 102 includes the delegation permissions 104, and a second delegation component 106 does not initially include the delegation permissions 104. The delegation permissions 104 comprise a delegator-delegatee relationship, wherein a delegator assigns delegation permissions to the delegatee. For example, the delegator can assign the delegatee the ability to schedule, edit, and/or delete a communications session (e.g., conference call or on-line meeting) on behalf of the delegator. The delegatee can then schedule and manage the communications session on behalf of the delegator from a scheduling application that may be included as part of a calendar application which can use a separate delegate permission model.

Further, the delegation system 100 includes a synchronization component 108 for synchronizing the delegation permissions 104 from the first delegation component 102 to the second delegation component 106. The synchronization component 108 interfaces to the first delegation component 102, reads the delegation permissions 104 configured and stored thereon, and determines whether the delegation permissions 104 exist in the second delegation component 106.

Initially, if it is determined that the delegation permissions 104 do not exist in either of the delegation components (102 and 106), then the synchronization component 108 facilitates establishment of the delegation permissions 104 in both of the delegation components (102 and 106).

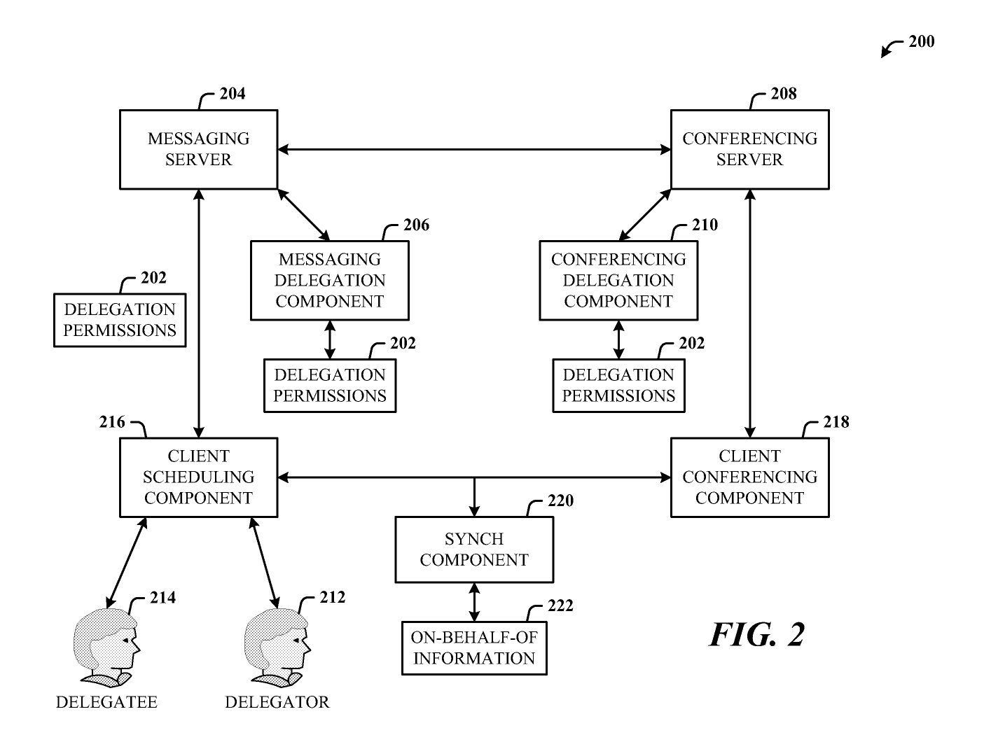

FIG. 2 illustrates an embodiment of a delegation system 200 for synchronizing delegation permissions 202 between messaging and conferencing servers. The delegation system 200 includes a messaging server 204 and associated messaging delegation component 206, and a communications server 208 (e.g., conferencing) with associated communications (conferencing) delegation component 210. The discrete delegation components (206 and 210) process the delegation permissions 202 as needed to validate delegator-delegatee relationships that are created for many different users of an enterprise, for example. The messaging server 204 can be a server that processes messaging, such email, text messaging, scheduling, calendars, etc. The conferencing server 208 can be a server that connects two or more users in a communications session in multi-modal communications (e.g., wired phone, wireless phone, computer, IP phones, etc.), text messaging, voice and/or audio, for example.

In operation, a delegator 212 (e.g., supervisor) desires that an assistant, for example, be a delegatee 214 in one or more systems. Accordingly, the delegator 212 configures the delegator-delegatee relationship as the delegation permissions 202 and uploads the permissions 202 to one of the servers, for example, the messaging server 204. Alternatively, the configuration process can be accomplished directly on the messaging server 204 and stored thereon. The delegatee 214 can interact with the messaging server 204 on behalf of the delegator 212.

Moreover, it can be the case where the delegatee 214 can interface to a client scheduling component 216 (e.g., messaging or email application) of the delegator 212 to interact with the delegator client scheduling component 216 as the delegator 212. Thus, the delegatee 214 can schedule events, read delegator messages, send delegator messages, etc., and perform other functions provided by the delegator client scheduling component 216. This can be controlled, however, based on the delegation permissions 202, such as prohibiting the sending of messages by the delegatee 214 via the delegator client.

Where the delegator client scheduling component 216 automatically interacts with a delegator client conferencing component 218 (e.g., conferencing application), to respond to conferencing event scheduling initiated by the delegatee 214, the delegation permissions 202 can further allow the delegatee 214 to schedule, edit, and/or delete a communications session (e.g., conference calls or on-line meetings) on behalf of the delegator 212.

Further, the delegation system 200 includes a synchronization (synch) component 220 for synchronizing the delegation permissions 202 between the messaging and conferencing systems. The synchronization component 220 can be a client-side add-in to either or both of the client scheduling component 216 or/and the client conferencing component 218.

The synchronization component 220 accesses the delegation permissions 202 stored on the messaging server 204 (the first server to which the delegation permissions 202 were created and configured), and determines if the delegation permissions 202 are present in the conferencing server 208. Specifically, if the synchronization component 220 determines that the delegator-delegatee relationship defined in the client scheduling component 216 and stored in the messaging server 204, does not exist in the conferencing server 208, then the synchronization component 220 sends a notification that the delegation permissions 202 are not present in the conferencing server 208. The synchronization component 220 then facilitates establishment of the delegator-delegatee relationship in the conferencing server 208.

Once the delegation permissions 202 are synchronized between the messaging server 204 and the conferencing server 208, the delegatee 214 can interact with the client scheduling component 216 and the client conferencing component 218 to perform some or all functions provided by the client scheduling component 216 and the client conferencing component 218. Specifically, when the delegatee 214 accesses the delegator client scheduling component 216 to schedule the communications session (e.g., conference call), the synchronization component 220 transmits on-behalf-of information 222 to the conferencing server 208. The on-behalf-of information 222 can be transmitted using an IP-based protocol such as a session initiation protocol (SIP) uniform resource identifier (URI) of the delegator 212. The on-behalf-of information 222 is sent to the conferencing server 208 in the protocol to provide permissions on the conference. Once the on-behalf-of information 222 is validated using the delegation permissions 202, the delegatee 214 can then establish the communications session and performed other allowed session functions.

A delegation header can be utilized to transmit the on-behalf-of information 222 to the conferencing server 208. The delegation header communicates the delegation actions of a delegatee 214 via an IP protocol, and the delegation header facilitates validation of the delegatee 214 according to the synchronized delegation permissions 202. The delegation header can be a P-session-on-behalf-of header; however, this is not a requirement, in that any suitable header can be employed for transmitting the on-behalf-of information 222 to the conferencing server 208.

More specifically, the delegatee 214 sends a communications session request, and the on-behalf-of information 22 is also sent to the conferencing server 208 with the SIP URI of the delegator 212. The conferencing server 208 receives the communications session request and on-behalf-of information 222 via the header. The conferencing server 208 reads the header, checks the delegation permissions 202 already stored locally with the conferencing delegation component 210, and validates the on-behalf-of information 222. If the header matches the delegation permissions 202 in the conferencing server 208, the conferencing server 208 processes the communications session request and creates the session based the on-behalf-of information 222 of the header.

It is to be understood that if the delegator 212 initially established the delegation permissions 202 in the conferencing server, the reverse can occur where a conferencing action via the client conferencing component 218 by the delegatee 214 or the delegator 212 will elicit a notification response that the delegation permissions 202 do not exist in the messaging server. This bi-directional checking and synchronization can occur between more than two servers where functions cause actions in other servers.

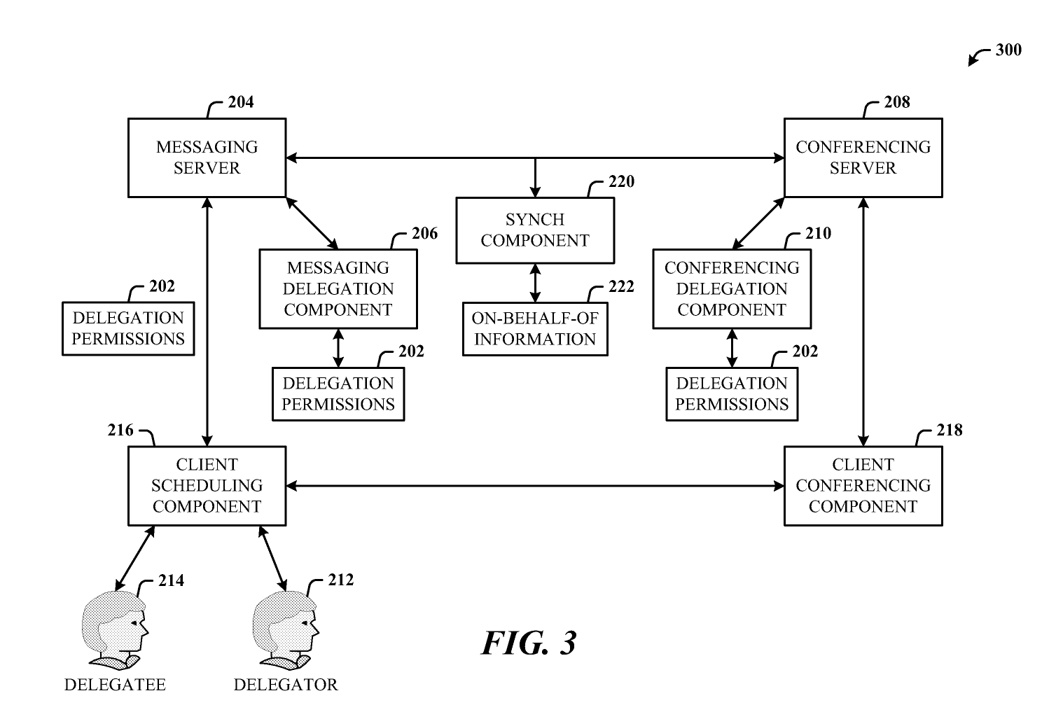

FIG. 3 illustrates an alternative embodiment of a delegation system 300 where synchronization is provided directly between servers. Here, the system 300 includes the same entities of the system 200 of FIG. 2; however, the synchronization component 220 is positioned in accordance with the server communications. Again using the example operations provided in system 200 of FIG. 2, once the delegator 212 establishes the delegation permissions 202 in the messaging server 204, the delegatee 214 can interact with the delegator client scheduling component 216 to schedule a session. The delegatee information (e.g., username, login data, etc.) is passed to the scheduling server 204 and validated by the messaging delegation component 206 against the stored delegation permissions 202.

Since a session is being scheduled, the client scheduling component 216 interacts with the delegator client conferencing component 218 to establish the session in the conferencing server 208. However, if the delegation permission 202 are not on the conferencing server 208, the conferencing server 208 can signal the client conferencing component 218 that the permissions 202 are not present. The client conferencing component 218 then signals the client scheduling component 216, which further signals the messaging server 204 and the associated synchronization component 220 to synchronize the permissions 202 of the messaging server 204 directly to the conferencing server 208.

An alternative communications protocol can be that once the conferencing server 208 receives a delegation action via the client conferencing component 218 by the delegatee 214, the conferencing server 208 checks the conferencing delegation component 210 for the matching delegation permissions 202. If the permissions 202 are not resident, the conferencing server 208 can automatically search other servers (e.g., the messaging server 204) for the suitable delegation permissions 202. Alternatively, the conferencing server 208 can signal the synchronization component 220 to seek out the delegation permissions 202 from the other servers. Once found, synchronization occurs, and the delegatee 214 can complete the session administration as provided by the delegator 212.

Once the delegation permissions 202 are synchronized between the messaging server 204 and the conferencing server 208, the on-behalf-of information 222 can be transmitted with the SIP URI of the delegator 212, as described above.

Put another way, the computer-implemented delegation system includes the delegator scheduling component that interfaces to the messaging server for scheduling items, and the delegator conferencing component that interfaces to the conferencing server for establishing and managing the communications session. The messaging server and the conferencing server include delegation permissions defined between the delegator and the delegatee. Further, the delegation system includes the synchronization component for synchronizing the delegation permissions between the messaging server and the conferencing server. The synchronization component determines whether the delegation permissions reside on both the messaging server and the conferencing server. If the delegation permissions do not exist on the conferencing server, the synchronization component sends notification that the delegation permissions do not reside on the conferencing server.

The synchronization component interfaces to both the delegator scheduling component and the delegator conferencing component, reads the delegation permission stored on the messaging server, and sends notification that the delegation permissions are not present in the conferencing server. Further, the synchronization component reads the delegation permissions stored in the messaging server and determines if the delegatee received delegation from the delegator on the conferencing server. Additionally, the delegatee accesses the delegator scheduling component to schedule the communications session, in response to which on-behalf-of information is transmitted to the conferencing server with a SIP URI of the delegator, and based on which the delegatee establishes the communications session.

Moreover, the synchronization component automatically synchronizes the delegation permissions between the messaging server and the conferencing server at predetermined time intervals. However, the synchronization can alternatively be manual or on an as-needed basis.

Furthermore, the delegation components and the synchronization component are part of a role-based security framework that includes a delegation role. The synchronization component synchronizes the delegation role between the delegation components.

In an alternative embodiment, the delegation system includes one server that includes both a messaging delegation component and a communications or conferencing delegation component. The delegation components process the delegation permissions for storage. The delegation permissions comprise delegator-delegatee relationships, wherein a delegator assigns delegate permissions to a delegatee. The delegatee can then schedule and manage conference calls or online meetings on behalf of a delegator from a calendaring (scheduling) application which uses a separate delegate permission model.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

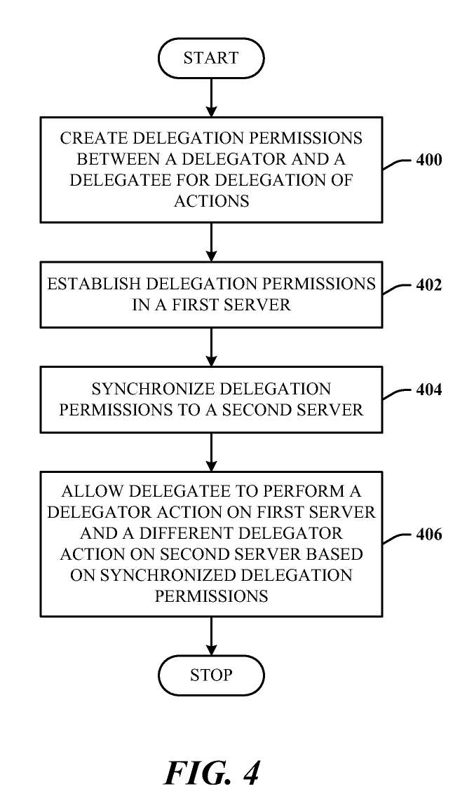

FIG. 4 illustrates a delegation method. At 400, delegation permissions are created between a delegator and a delegatee for the delegation of actions. The delegation permissions comprise delegator-delegatee relationships, wherein the delegator assigns delegation permissions to the delegatee to schedule, edit, change, update, set modalities, delete, etc., a communications session (e.g., conference calls, on-line meetings, etc.) on behalf of the delegator. At 402, the delegation permissions are established in a first server. At 404, the delegation permissions are synchronized to a second server. The synchronization determines whether the delegator-delegatee relationship defined in the first server exists in the second server, and if the delegator-delegatee relationship does not exist in the second server, synchronization facilitates establishment of the delegator-delegatee relationship in the second server. At 406, the delegatee is allowed to perform a delegator action on the first server and a different delegator action on the second server based on the delegation permissions. Once the delegation permissions are synchronized between the first and second servers, the delegatee can perform the allowed functions for the delegator.

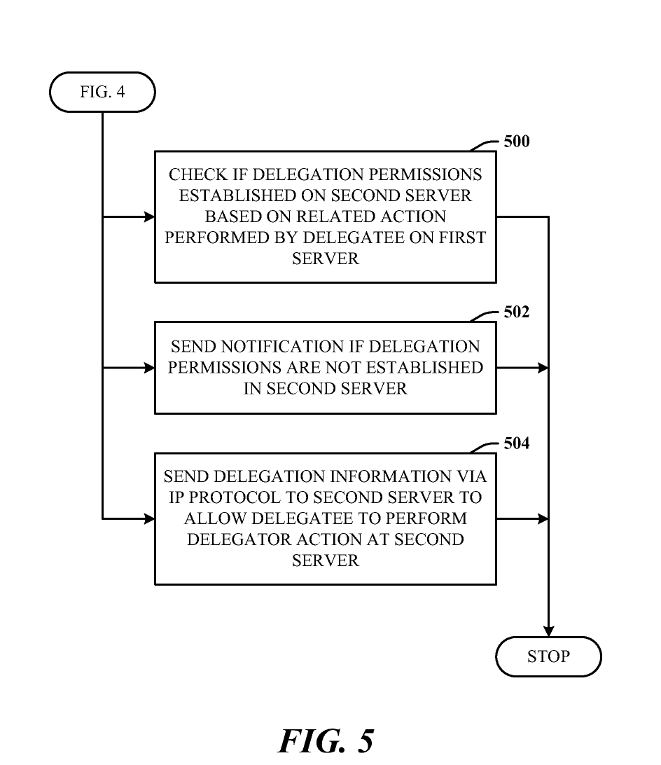

FIG. 5 illustrates further aspects in the delegation method of FIG. 4. At 500, delegation permissions are checked to determine if the delegation permissions are established on a second server based on a related action performed by a delegatee on a first server. At 502, notification is sent (e.g., to the delegatee) if the delegation permissions are not established in the second server. At 504, delegation information is sent via an IP protocol to the second server, which allows the delegatee to perform the delegator action at the second server.

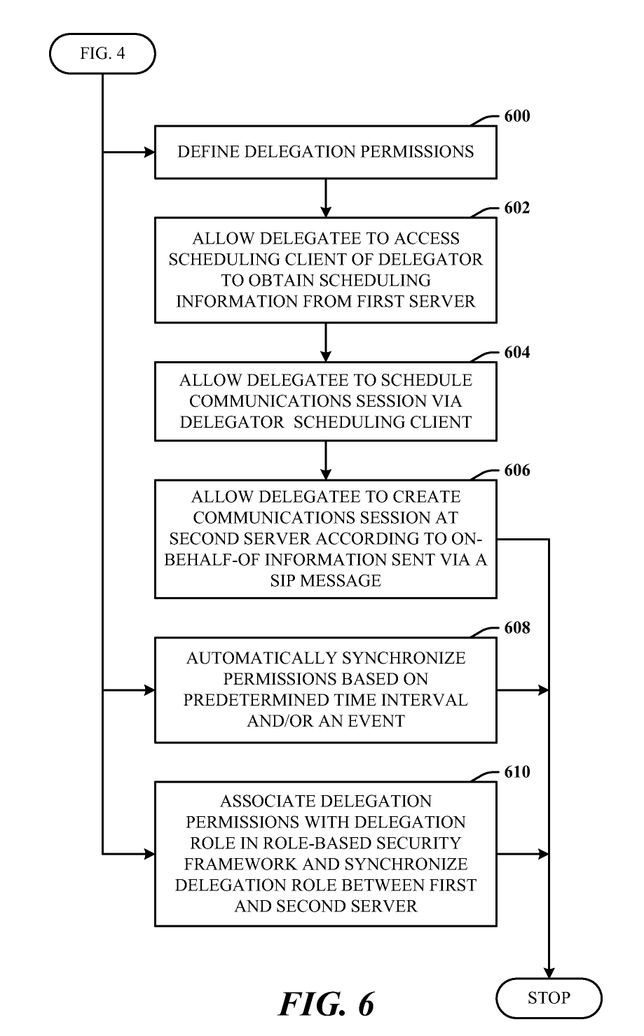

FIG. 6 illustrates still further aspects in the delegation method of FIG. 4. At 600, the delegation permissions are defined. The delegation permissions include: at 602, allowing a delegatee to access a scheduling client of the delegator to obtain scheduling information from the first server; at 605, allowing the delegatee to schedule a communications session via the delegator scheduling client; and at 606, allowing the delegatee to create the communications session at the second server according to on-behalf-of information sent via a SIP message. At 608, the delegation permissions are automatically synchronized based on predetermined time interval and/or event. At 610, the delegation permissions are associated with a delegation role in a role-based security framework, and the delegation role is synchronized between the first server and the second server.

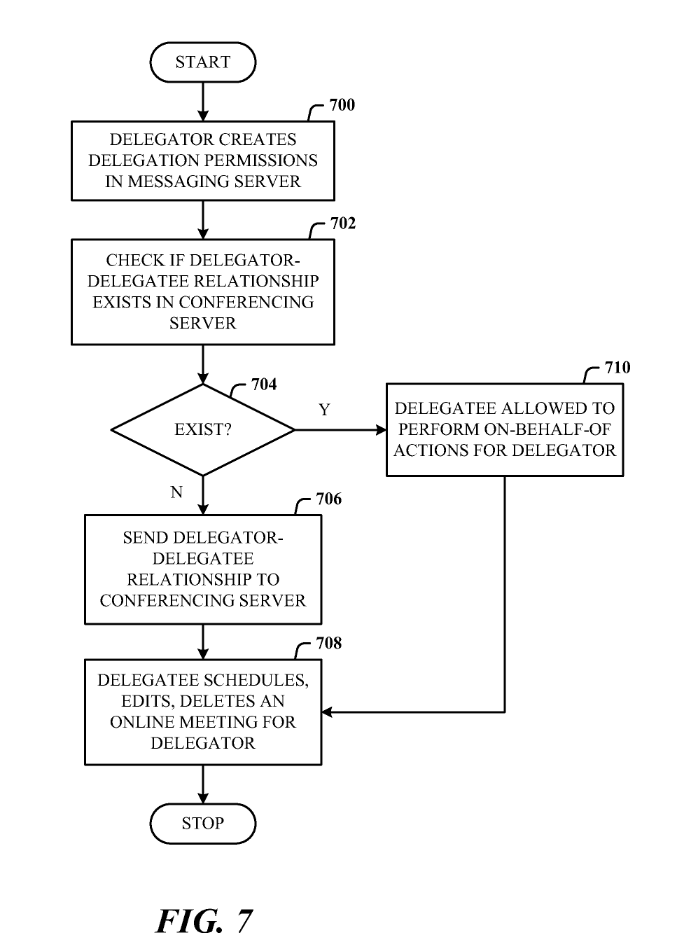

FIG. 7 illustrates a more specific method of synchronizing delegation permissions between a messaging server and a conferencing server. At 700, the delegator creates delegation permissions in the messaging server. For example, the delegator can create the permissions via an add-in (synchronization component) to a scheduling application or a calendaring application. The synchronization component can read the delegation permissions from the messaging server after install of the synchronization component and the scheduling component is used. At 702, a check is made to determine if the delegator-delegatee relationship exists in the conferencing server.

If no, at 704, flow is to 706, where the delegator-delegatee relationship is sent to the conferencing server. At 708, the delegatee can then schedule, edit, and/or delete a session (e.g., online meeting) for the delegator. If, at 704, the relationship (delegation permissions) exists on the conferencing server, then the delegatee is allowed to perform on-behalf-of actions for the delegator. Flow is then to 708.

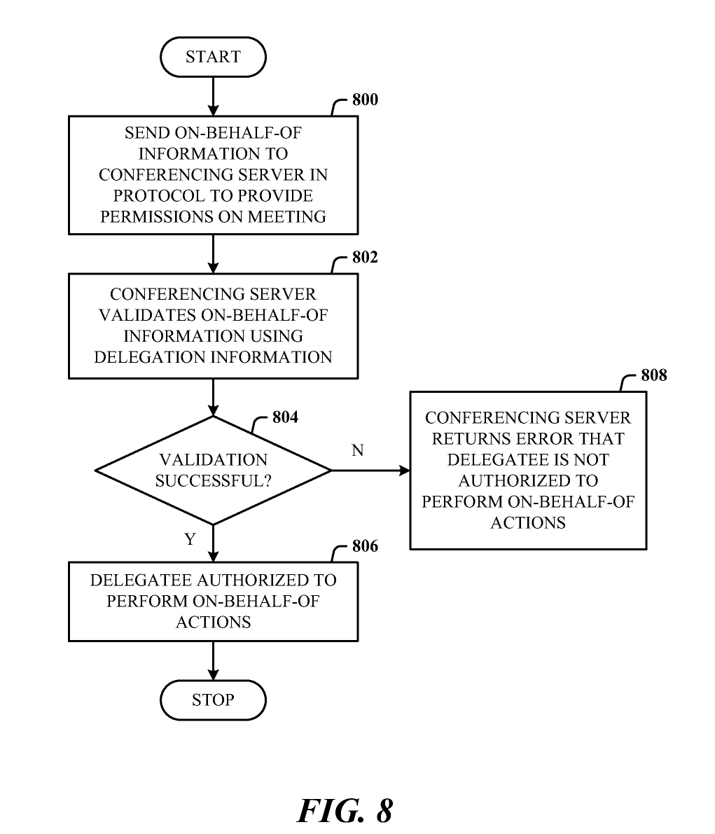

FIG. 8 illustrates a method of sending on-behalf-of information to a conferencing server. This method relates to the flow described in accordance with the scenario of FIG. 7. At 800, the on-behalf-of information is sent to the conferencing messaging server in a protocol header to provide permissions for the meetings. At 802, the conferencing server validates the information in the protocol using the delegation permissions. The conferencing server reads the header and checks the delegation permissions residing on the conferencing server. At 804, if validation is successful (the header matches with the delegation permissions), flow is to 806 where the delegatee is authorized to perform on-behalf-of actions (the meeting is created with the delegator as the organizer). If validation is not successful, flow is from 804 to 808 where the conferencing server returns an error that the delegatee is not authorized to perform the on-behalf-of actions.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

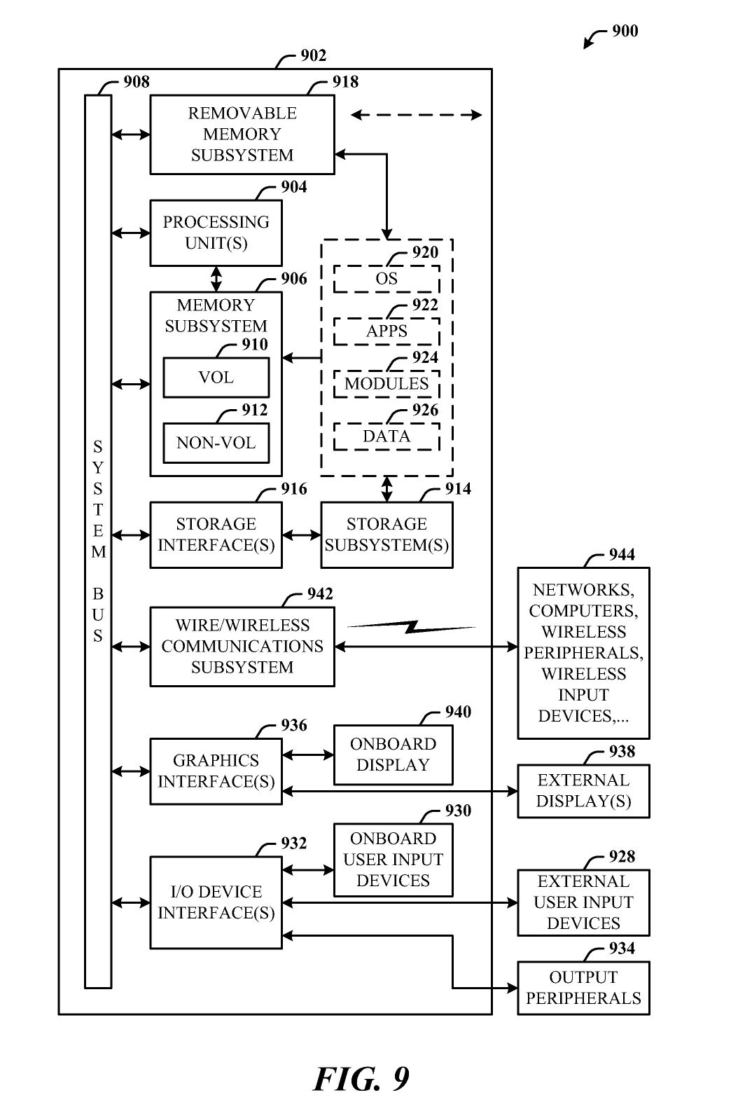

Referring now to FIG. 9, there is illustrated a block diagram of a computing system 900 operable to execute delegation synchronization in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The aforementioned application programs 922, program modules 924, and program data 926 can include the computer-implemented system 100 of FIG. 1, to include the delegation components (102 and 106), the delegation permissions 104, and the synchronization component 108, the entities and components of system 200 of FIG. 2, including the messaging server 204, the conferencing server 208, the messaging delegation component 206, the conferencing delegation component 210, the client scheduling component 216, the client conferencing component 218, the synchronization component 220, and the on-behalf-of information 222, and, the entities and components and arrangement of system 300 of FIG. 3.

The aforementioned application programs 922, program modules 924, and program data 926 can also include the methods represented by flow charts of FIGS. 4-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wired/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

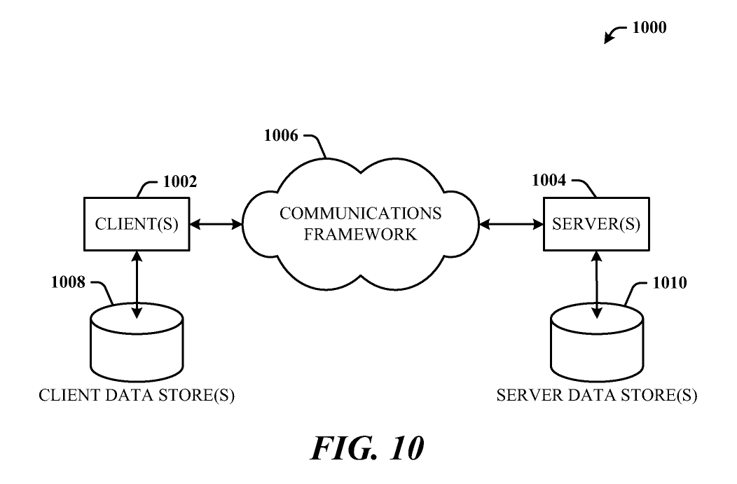

Referring now to FIG. 10, there is illustrated a schematic block diagram of a computing environment 1000 operable to provide delegation synchronization. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented delegation system, comprising:
discrete delegation components for processing delegation permissions; and
a synchronization component for synchronizing the delegation permissions between the delegation components.

2. The system of claim 1, further comprising a messaging server that includes a messaging delegation component and a communications server that includes a communications delegation component, the synchronization component synchronizing the delegation permissions between the messaging delegation component and the communications delegation component.

3. The system of claim 2, wherein the messaging delegation component processes scheduling delegation permissions related to scheduling a conference and the communications delegation component processes the conferencing delegation permissions to establish and manage the conference.

4. The system of claim 1, wherein the synchronization component determines that a delegator-delegatee relationship defined in a first delegation component does not exist in a second delegation component, and facilitates establishment of the delegator-delegatee relationship in the second delegation component.

5. The system of claim 1, further comprising a delegation header for communicating a delegation action of a delegatee via an IP protocol, the delegation header facilitates validation of the delegatee according to the delegation permissions.

6. The system of claim 1, wherein the delegation permissions identify a delegatee that at least one of schedules, edits, or deletes a communications session on behalf of a delegator.

7. The system of claim 1, wherein the synchronization component automatically synchronizes the delegation permissions between the delegation components at predetermined time intervals.

8. The system of claim 1, wherein the delegation components and the synchronization component are part of a role-based security framework that includes a delegation role, the synchronization component synchronizes the delegation role between the delegation components.

9. A computer-implemented delegation system, comprising:
a delegator scheduling component that interfaces to a messaging server for scheduling items, and a delegator conferencing component that interfaces to a conferencing server for establishing and managing a communications session; and
delegation permissions defined between a delegator and a delegatee; and
a synchronization component for synchronizing the delegation permissions between the messaging server and the conferencing server.

10. The system of claim 9, wherein the synchronization component sends notification that the delegation permissions do not reside on a server.

11. The system of claim 9, wherein the synchronization component interfaces to both the delegator scheduling component and the delegator conferencing component, reads the delegation permission stored on the messaging server, and sends notification that the delegation permissions are not present in the conferencing server.

12. The system of claim 9, wherein the synchronization component reads the delegation permissions stored in the messaging server and determines if the delegatee receives delegation from the delegator on the conferencing server.

13. The system of claim 9, wherein the delegatee accesses the delegator scheduling component to schedule the communications session, in response to which on-behalf-of information is transmitted to the conferencing server with a SIP URI of the delegator, and based on which the delegatee establishes the communications session.

14. A computer-implemented delegation method, comprising:
creating delegation permissions between a delegator and a delegatee for the delegation of actions;
establishing the delegation permissions in a first server;
synchronizing the delegation permissions to a second server; and
allowing the delegatee to perform a delegator action on the first server and a different delegator action on the second server based on the synchronized delegation permissions.

15. The method of claim 14, further comprising checking if the delegation permissions are established on the second server based on a related action performed by the delegatee on the first server.

16. The method of claim 14, further comprising sending notification if the delegation permissions are not established in the second server.

17. The method of claim 14, further comprising sending delegation information via an IP protocol to the second server, which allows the delegatee to perform the delegator action at the second server.

18. The method of claim 14, further comprising defining the delegation permissions to allow:
allowing a delegatee to access a scheduling client of the delegator to obtain scheduling information from the first server;
allowing the delegatee to schedule a communications session via the delegator scheduling client; and
allowing the delegatee to create the communications session at the second server according to on-behalf-of information sent via a SIP message.

19. The method of claim 14, further comprising automatically synchronizing the delegation permissions based on at least one of a predetermined time interval or an event.

20. The method of claim 14, wherein the delegation permission are associated with a delegation role in a role-based security framework, and the delegation role is synchronized between the first server and the second server.
